(19) United States
(12) Patent Application Publication
(10) Pub. No.: US 2014/0138955 A1
(43) Pub. Date: May 22, 2014

(54) VERTICAL AXIS MOORING ROTOR

(71) Applicant: Paul Fransen, Den Haag (NL)

(72) Inventor: Paul Fransen, Den Haag (NL)

(21) Appl. No.: 13/682,413

(22) Filed: Nov. 20, 2012

(51) Int. Cl. F03B 13/10

(52) U.S. Cl. CPC F03B 13/10
USPC 290/54

(57) ABSTRACT

The present invention named “Vertical axis mooring rotor” relates in general to the field of rotor designs aiming at utilizing the currents of oceans and seas and rivers to generate electricity. Its design combines this electricity generating function with the function of a mooring system. Ships ore other large floating bodies act like rotor blades with a specific freedom to change position in order to produce maximum resistance when encountering water flow in one direction, and either minimum resistance, when encountering water flow in the opposite direction. By this it will use leverage as a main characteristic for harnessing the power of relatively slow river and ocean currents by vertical axis rotors. At the same time it might also function as a conventional mooring point for ships or other large floating bodies in a waiting state.

### DESCRIPTION TECHNICAL FIELD & BACKGROUND

Directly related u.s. and international application data for this invention: Request for Non-Provisional application No. US 13091149, filed on Apr. 21, 2011. European patent, application No. EP10165597.5-1267, Publ. nr. 2381090. The present invention relates in general to the field of rotor designs aiming at utilizing the currents of oceans and seas and rivers to generate electricity. Its design combines this electricity generating function with the function of a mooring system. Ships or other floating bodies moored to the system act like rotor blades with a specific freedom to change position in order to produce maximum resistance when encountering water flow in one direction, and either minimum resistance, when encountering water flow in the opposite direction.

Present state-of-the art water powered electrical power generating systems are still based on the paradigm of relatively small water volume passage with relatively high speed. Most of these systems have the character of (adapted) turbines. The diameter of these devices is usually expressed in terms of less than 30 yards. The use of leverage power is not a dominant quality. Therefore these designs are not able to make sufficient use of the extensive power of the vast volumes of slow sea or river currents.

Also in the field of vertical axed rotor designs, using blades that when rotating produce maximum drag when encountering water flow in one direction, and either minimum drag, when encountering water flow in the opposite direction, the diameter always stayed limited, due to the fact that the paradigm of (relatively small) water volume passage with (relatively) high speed was never left. These designs could never compete with the turbines, and were never successful.

The present invention utilizes a design which makes very large diameters possible, catching the pressure of vast volumes of slow streaming currents, deliberately using leverage to deliver tremendous power to a central rotating hub, being the starting gear wheel to transfer this power to one ore more electric generators. This design, using ships or other large floating bodies, being moored to the rotor, is new in the design of water powered electrical power generating systems.

By positioning the central rotation axis vertically, using vertically flexible spokes equipped with facilities to function as mooring places for ships or other large floating bodies that have a preset freedom to reposition themselves, it is made possible to extend the diameter of the rotor to such a scale that the use of leverage power becomes a dominant factor. The design thereby operates with water flow from any direction, eliminating the need to rotate the entire structure to face the water flow. As a one-line description the design can be called a “leverage maximizing vertical axis planetary mooring rotor device”, but in the following the term “mooring rotor” is used. As not only ships, but also other large floating bodies can be moored onto a mooring system, the term moored body (which also comprises ships) will be used in the following.

The mooring rotor is rotating around a fixed pipe or pillar. This pillar can be driven into the bottom of a river, lake or ocean/sea, it can be mounted on a foundation on the bottom of a river, lake or ocean/sea; and it can be mounted on a floating body anchored to the bottom of an ocean or river.

The rotor spokes can be positioned above or below the water level. Positioned below the water level the design of the spoke is adapted to supply additional driving power by its special shape. This special shape also provides a certain vertical flexibility to the spokes, comparable to the wings of large airplanes. Positioned above water level and carried by floaters, the spokes are constructed to be strong enough to cope with the forces of the waves in extreme circumstances. The strength of this construction is dependent of the geographic situation. It must be evident that there is a difference between ocean/sea applications and applications in rivers.

For further transmission of the rotating power from the starting gear wheel to the electricity generators a transmission system in a housing constructed on the fixed central axis is needed. As such transmission systems and generators (e.g. large Permanent Magnet Generators) are well known technology they are not described in detail, but only pointed out to be natural components to make use of this invention.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a drawing of a an axonometric view of a mooring rotor with 3 spokes above water level, in accordance with one embodiment of the present invention.

FIG. 2 illustrates a drawing of a top view of a mooring rotor with 3 spokes above water level, in accordance with one embodiment of the present invention.

FIG. 3 illustrates a drawing of a second top view of a mooring rotor with 3 spokes above water level, in accordance with one embodiment of the present invention.

FIG. 4 illustrates a drawing of a third top view of a mooring rotor with 3 spokes above water level, in accordance with one embodiment of the present invention.

FIG. 5 illustrates a drawing of a fourth top view of a mooring rotor with 3 spokes above water level, in accordance with one embodiment of the present invention.

FIG. 6 illustrates a drawing of a front view (looking downstream) of a mooring rotor with 3 spokes above water level, in accordance with one embodiment of the present invention.

FIG. 7 illustrates a drawing of a an axonometric view of a mooring rotor with 3 spokes under water level, in accordance with one embodiment of the present invention.

FIG. 8 illustrates a drawing of an axonometric view of the starting gear wheel being the upper part of the central hub of a mooring rotor with 3 spokes above water level, in accordance with one embodiment of the present invention.

FIG. 9 illustrates a drawing of a sectional plane view of a below water level spoke, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

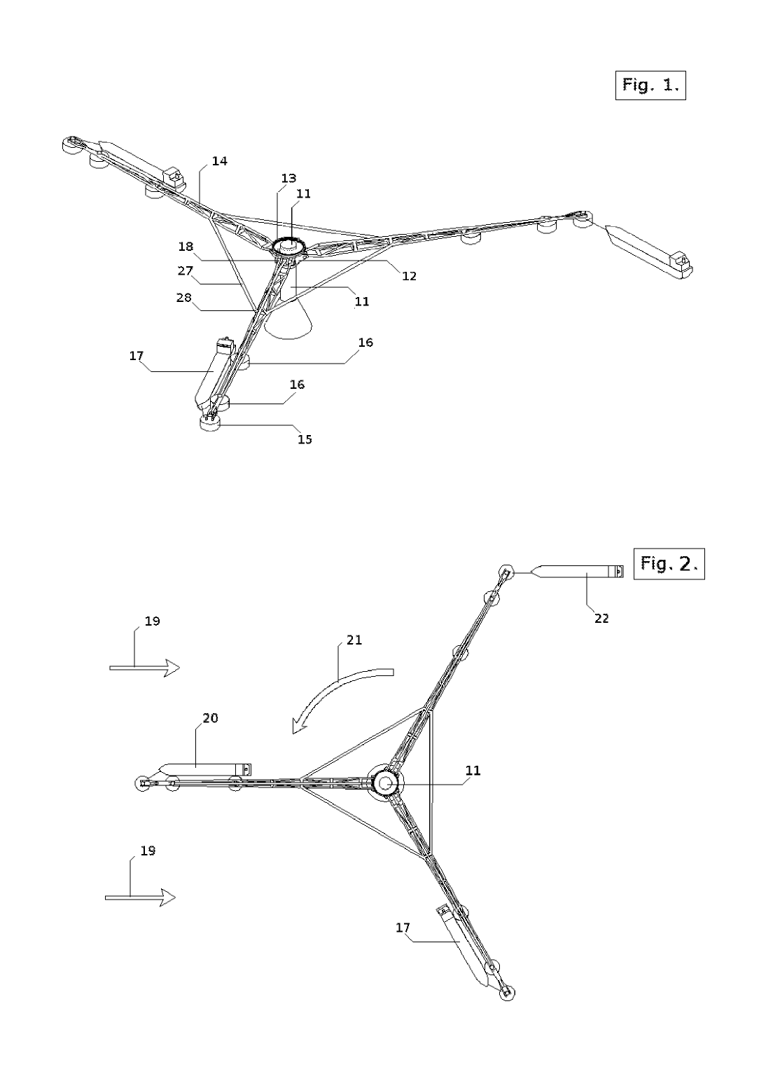

Now referring to FIG. 1, as in one embodiment of the present invention, shown is an axonometric view of a mooring rotor with 3 spokes above water level. Shown is a fixed central axle 11 with rotating hub 12, the upper ring 13 of the hub being the starting gear wheel to transmit power (see FIG. 8). Shown are the spokes 14, illustrated here as a strong but open construction to withstand the force of waves and wind, being connected to the hub 12 by a robust hinge construction 18, allowing vertical movement. This movement is needed to cope with different water levels (high tide, low tide) and with the influence of major waves at the surface. Strut bars 27 with flexible connections 28 to the spokes, prevent to much sideways pressure to the hinge construction. Floaters 15,16 carry the spoke. Floater 15 services as a single mooring connection point and facilitates the moored body 17 to position itself in full length parallel to the spoke, resting against the other floaters 16, when forced so by the stream (see FIGS. 2-6). This connection point also facilitates the situation when as a consequence of the circular movement of the mooring rotor the moored body 17 is passing the point where the pressure of the stream will rotate it away from its position parallel against the spoke to a new position with minimal resistance to the current. (see FIGS. 2-6)

Referring to FIG. 2 as in one embodiment of the present invention, shown is a top view of a mooring rotor with 3 spokes. The position of the moored bodies referring to the direction of the current 19 is as follows: The moored body 20 most stream upwards is just in a position parallel to the spoke and by this has lost its freedom to adapt its position freely to minimize its resistance to the stream. The moored body 17 already parallel positioned to and being pushed against the spoke by the stream receives most of the power from the current and causes the rotor to rotate counterclockwise 21 around the central axle 11. The moored body 22 by its freedom to adapt its position freely delivers minimal resistance to the current and is towed upwards the stream.

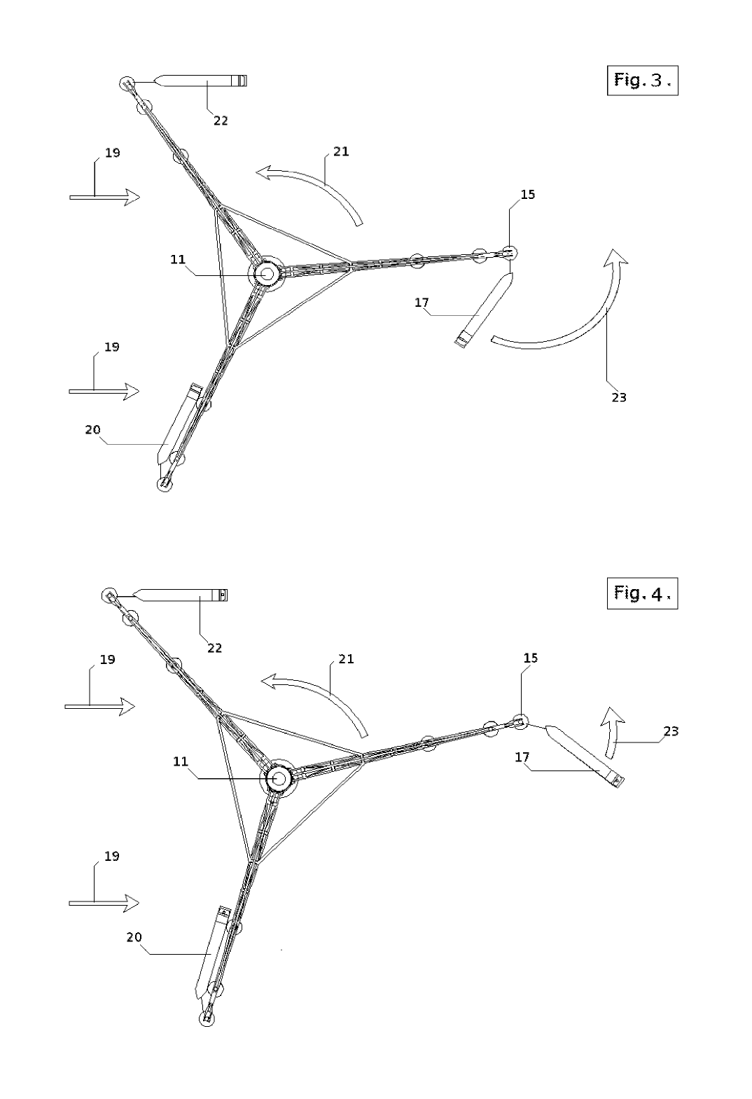

Referring to FIG. 3 as in one embodiment of the present invention, shown is a top view of a mooring rotor with 3 spokes. The position of the moored bodies referring to the direction of the current 19 is as follows: The moored body 20 already parallel positioned against the spoke receives most of the power from the current and causes the rotor to rotate counterclockwise 21 around the central axle 11. The moored body 17 most stream downwards is rotating also counterclockwise 23 around the mooring point floater 15 away from its position parallel to the spoke and is turning to find a position with the least resistance to the current. The moored body 22 delivers minimal resistance to the current and is towed upwards the stream.

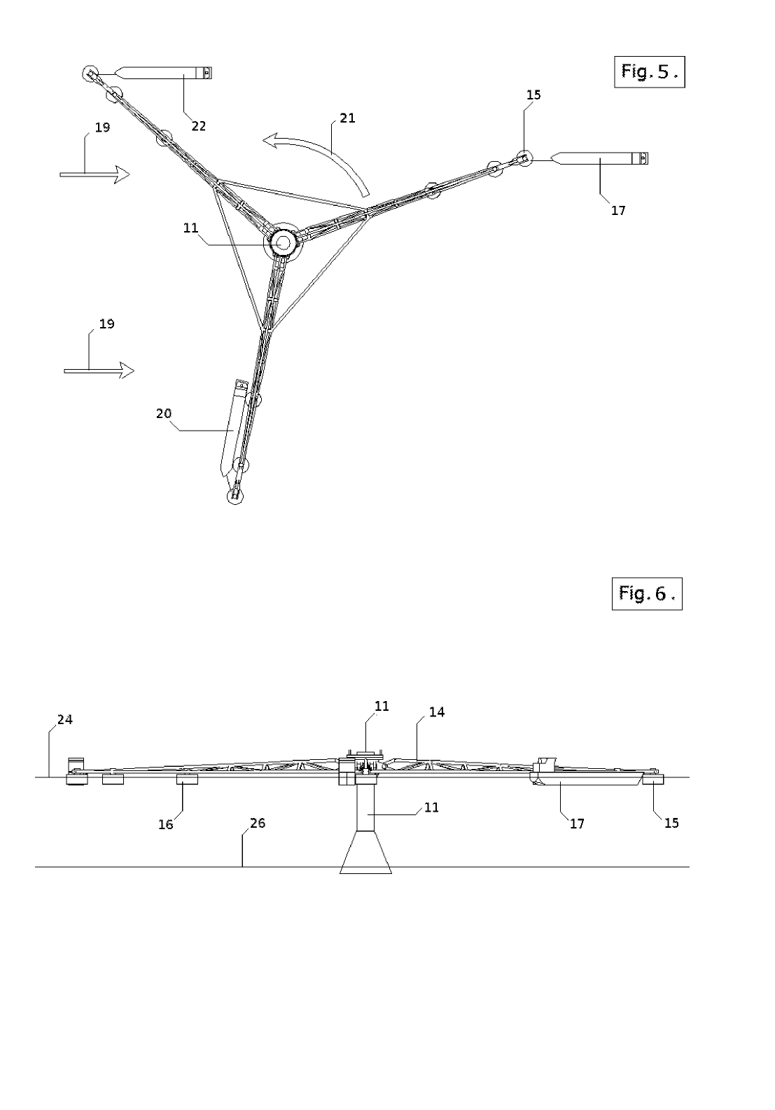

Referring to FIG. 4 as in one embodiment of the present invention, shown is a top view of a mooring rotor with 3 spokes. This drawing is almost identical to FIG. 3, illustrating the further rotating of the moored body 17 most stream downwards counterclockwise 23 around the mooring point floater 15, turning to find a position with the least resistance to the current.

Referring to FIG. 5 as in one embodiment of the present invention, shown is a top view of a mooring rotor with 3 spokes. The position of the moored bodies referring to the direction of the current 19 is as follows: The moored body 20 already parallel positioned against the spoke receives most of the power from the current and causes the rotor to rotate counterclockwise 21 around the central axle 11. The moored body 22 delivers minimal resistance to the current and is towed upwards the stream. The moored body 17 most stream downwards has rotated to its position to deliver minimal resistance to the current and is also towed upwards the stream.

Referring to FIG. 6 as in one embodiment of the present invention, shown is a front view (looking downstream) of a mooring rotor with 3 spokes. As shown the central rotating hub 12 rotates around the fixed central axle 11. The fixed central axle 11 is driven into the bottom 26. The moored bodies 17, 20 floating on the surface 24 are parallel positioned against the spokes. The moored body 22 delivers minimal resistance to the current and is towed upwards the stream. The floaters 15,16 are carrying the weight of the spokes 14.

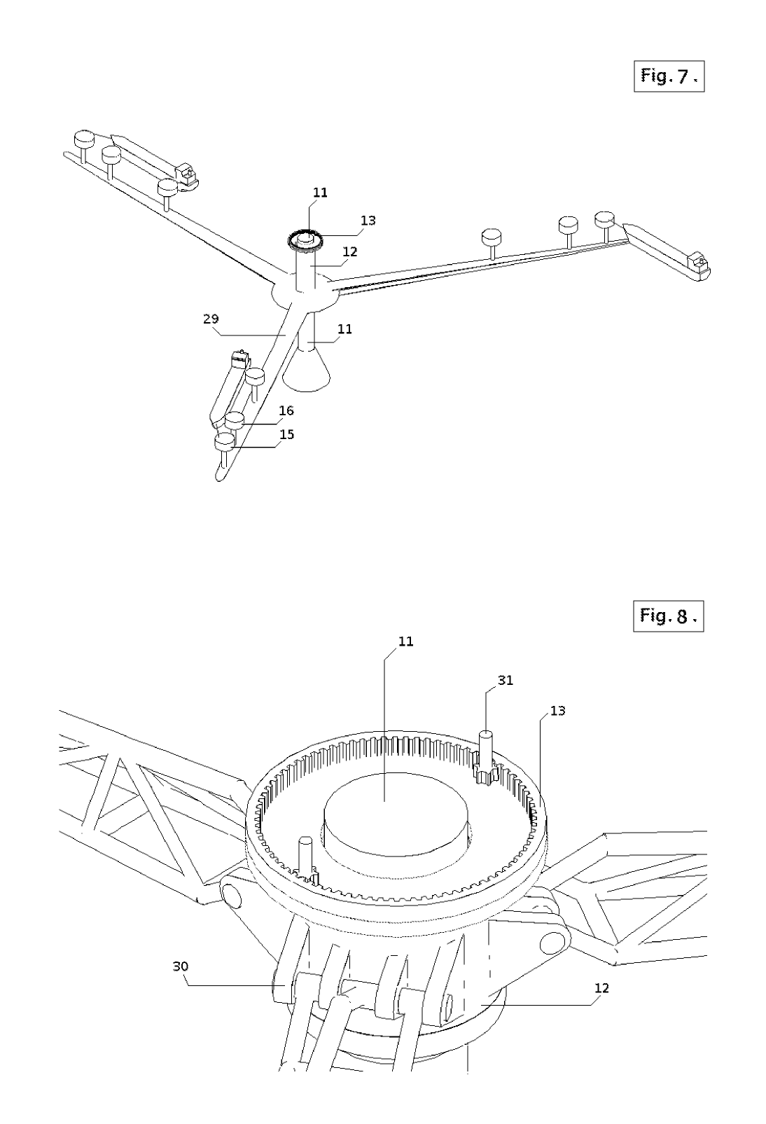

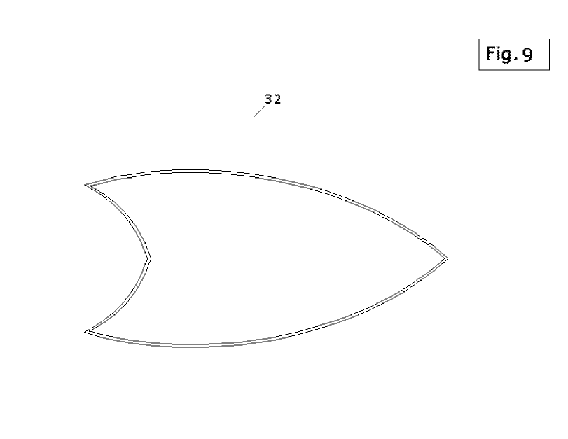

Referring to FIG. 7, as in one embodiment of the present invention, shown is an axonometric view of a mooring rotor with 3 spokes below water level and mooring floaters at water level. Shown is a fixed central axle 11 with rotating hub 12, the upper ring 13 of the hub being the starting gear wheel to transmit power. Shown are the under water spokes 29, being fixed connected to the hub, but by their design and construction relatively flexible in upwards and downwards movement, like the wings of a large airplane. This flexibility is needed to cope with the underwater movement caused by waves and the mooring floaters 15,16 at the surface. These spokes are shaped with a sharp edge at one side and a hollow shape at the other side (see FIG. 9) to derive additional power from the current.

Referring to FIG. 8 as in one embodiment of the present invention, shown is an axonometric view of the starting gear wheel 13 and hinge construction 30 as a part of the central rotating hub 12 of a mooring rotor with spokes above water level. This illustrates the robustness of the hinge construction. Also shown are the small cogwheels and a part of their axles 31 that will transfer the rotation from the starting gear wheel to the gear unit housing (not shown here), which is mounted on the fixed central axis-pillar 11.

Referring to FIG. 9 as in one embodiment of the present invention, shown is a drawing of a sectional plane view 32 of a below water level spoke. This illustrates that also these spokes when rotating are contributing to produce maximum drag when encountering water flow in one direction, and either minimum drag, when encountering water flow in the opposite direction.

What is claimed is:

1. A vertical axis mooring rotor, comprising: a central axle unit consisting of a fixed shaft and a rotating spoke hub, the spoke hub having at least three rotor spokes that have a certain degree of vertical flexibility to cope with differences in water level or vertical water movements, each spoke floating itself or carried by floaters and functioning itself or its floaters as a mooring place for ships ore other floating bodies as large as ships or less large like tree trunks, which are attached to the spoke or the floaters in such a way that those ships ore other floating bodies, when forced by the stream in one direction, produce maximum drag in encountering the fluid flow and when towed in the opposite direction produce minimum drag in encountering the fluid flow, thus making the rotor rotate in a relatively slow speed, producing by leverage (due to the spoke length) and the huge volumes of the floating bodies (e.g. oil tankers) extremely forceful torque, to be used for generating electricity.

2. The vertical axis mooring rotor of claim 1 wherein the spoke hub is rotating around a fixed pipe or pillar driven into the bottom of a sea, river, lake, channel or other streaming water containing geographical phenomenon, or rotating around a fixed pipe or pillar supported by a foundation construction on the bottom of a sea, river, lake, channel or other streaming water containing geographical phenomenon.

3. The vertical axis mooring rotor of claim 1 wherein the spoke hub is rotating around a fixed pipe or pillar mounted on a on or below the water surface floating body, held in position by anchors connected to the bottom of a sea, river, lake, channel or other streaming water containing geographical phenomenon.

4. The vertical axis mooring rotor of claim 1 wherein the spoke hub is extended with an upper ring to be used as the starting gear wheel to transfer power to one ore more electric generators.

5. The vertical axis mooring rotor of claim 1 wherein the connection between spoke hub and spokes is vertically flexible by the use of a hinge construction.

6. The vertical axis mooring rotor of claim 1 wherein the rotor spokes are fixed connected to the spoke hub, but vertically flexible by their structure and materials used, like the wings of large airplanes

7. The vertical axis mooring rotor of claim 1 wherein the flexible rotor spokes are shaped with a sharp edge at one side and a hollow shape at the other side to derive additional power from the current to provide additional power supply.

8. The vertical axis mooring rotor of claim 1 wherein the rotor spokes are situated above the water level and wherein the moored floating bodies are situated at the water level.

9. The vertical axis mooring rotor of claim 1 wherein the rotor spokes are situated under the water level and wherein the moored floating bodies are situated at the water level.

10. The vertical axis mooring rotor of claim 1 wherein the rotor spokes are situated under the water level and wherein the moored floating bodies are situated under the water level.
